(19) United States
(12) Patent Application Publication
(10) Pub. No.: US 2026/0281757 A1
(43) Pub. Date: Sep. 17, 2026

(54) UE-SPECIFIC CHANNEL BANDWIDTH FOR SELF-INTERFERENCE MITIGATION

(71) Applicant: T-Mobile USA, Inc., Bellevue, WA (US)

(72) Inventors: William SHVODIAN, McLean, VA (US); Hui-Hsia SUNG, Bellevue, WA (US)

(21) Appl. No.: 19/076,892

(22) Filed: Mar. 11, 2025

(51) Int. Cl. H04W 24/08; H04B 7/06; H04B 17/318; H04W 52/14

(52) U.S. Cl. CPC H04W 24/08; H04B 7/0626; H04B 17/328; H04W 52/146

(57) ABSTRACT

Solutions are disclosed that reduce self-interference for frequency division duplexing (FDD) communication in wireless networks (i.e., reducing a radio's transmitter interference with its own reception). For cellular communications, as an example, different UE-specific channel bandwidths (UE-specific CHBWs) in the uplink (UL) channel, with different bandwidths and/or different center frequencies, produce differing levels of self-interference in the downlink (DL) channel. A scheduler selects from among various UE-specific CHBWs for user equipment (UE) based on each UE's ability to withstand interference, and awareness of the interference profiles of the different UE-specific CHBWs. For example, a UE far from a base station antenna receives a relatively weak signal and yet uses high transmit power. For such a UE, the use of a UE-specific CHBW that produces lower levels of interference is more important than it is for UEs closer to the base station that enjoy higher received power while transmitting at lower power

### BACKGROUND

Modern cellular networks, such as fifth generation (5G) cellular networks and likely later generations, employ Frequency Division Duplexing (FDD) in at least some frequency bands. FDD is a communication technique in which uplink (UL) and downlink (DL) communications are transmitted at different frequencies, with a duplex gap separating UL and DL frequencies in order to mitigate interference. The UL channel is used for user equipment (UE, e.g., cellphone) transmission to the base station, and the DL channel is used for base station transmissions to the UE. Self-interference occurs when a UE's own UL transmissions interfere with its reception of DL signals from the base station.

Unfortunately, the interference between UL and DL channels is not entirely eliminated by the duplex filter if the UL and DL channels are relatively close in frequency. The self-interference problem tends to be worse when the UE is near the outer limits of a cell, because the UE's transmission strength tends to be higher (self-interfering signals are more powerful) while the signals received from the base station are lower in power.

### SUMMARY

The following summary is provided to illustrate examples disclosed herein, but is not meant to limit all examples to any particular configuration or sequence of operations.

Solutions are disclosed that provide for user equipment (UE) specific channel bandwidth for self-interference mitigation. Examples monitor, by a base station, for a first UE, a first radio signal quality parameter for a downlink (DL) channel of a wireless frequency band and a transmit power for an uplink (UL) channel of the wireless frequency band; monitor, by the base station, for a second UE, a second radio signal quality parameter for the DL channel of the wireless frequency band and a transmit power for the UL channel of the wireless frequency band; and based on at least the first radio signal quality parameter meeting a first radio signal quality performance condition and the second radio signal quality parameter not meeting the first radio signal quality performance condition: assign a first UE-specific channel bandwidth (UE-Specific CHBW) of the UL channel to the first UE for transmission, wherein transmitting using the first UE Specific CHBW generates a first relative level of interference in the DL channel; and assign a second UE-specific CHBW of the UL channel to the second UE for transmission, wherein transmitting using the second UE-specific CHBW generates a second relative level of interference in the DL channel, wherein the second UE-specific CHBW has less bandwidth than the first UE-specific CHBW, and wherein the second relative level of interference is lower than the first relative level of interference.

### BRIEF DESCRIPTION OF THE DRAWINGS

The disclosed examples are described below with reference to the accompanying drawing figures listed below, wherein:

FIG. 1 illustrates an exemplary architecture that advantageously employs user equipment (UE) specific channel bandwidth for self-interference mitigation;

FIG. 2 illustrates a possible scenario in which the UE-specific channel bandwidth of the architecture of FIG. 1 mitigates self-interference;

FIG. 3 illustrates exemplary UE specific channel bandwidths (UE-specific CHBWs) that may be used in examples of the architecture of FIG. 1;

FIGS. 4A, 4B, and 4C illustrate exemplary power spectral density plots for different UE-specific CHBWs that may be used in examples of the architecture of FIG. 1;

FIG. 5 illustrates further detail for an exemplary scheduler that may be used for assigning UE-specific CHBWs to UEs in examples of the architecture of FIG. 1;

FIGS. 6A, 6B, 7, and 8 illustrate flowcharts of exemplary operations associated with the architecture of FIG. 1; and

FIG. 9 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that reduce self-interference for frequency division duplexing (FDD) communication in wireless networks (i.e., reducing a radio's transmitter interference with its own reception). For cellular communications, as an example, different UE-specific Channel BWs (UE-specific CHBWs) in the uplink (UL) channel, with different bandwidths and/or different center frequencies, produce differing levels of self-interference in the downlink (DL) channel. A scheduler selects from among various UE-specific CHBWs for user equipment (UE) based on each UE's ability to withstand interference, and awareness of the interference profiles of the different UE-specific CHBWs. For example, a UE far from a base station antenna receives a relatively weak signal and yet uses high transmit power. For such a UE, the use of a UE-specific CHBW that produces lower levels of interference is more important than it is for UEs closer to the base station that enjoy higher received power while transmitting at lower power levels.

In addition to UE specific CHBWs, the network also assigns UEs to Bandwidth Parts (BWPs), which may be identical to the UE specific CHBWs. However, BWPs may not mandate the radio frequency (RF) configuration of a UE. Thus, the term UE specific CHBW is used, which may include BWPs when only BWPs are used (rather than a separate BW assignment) and an assigned BWP also controls the RF configuration of a UE.

Aspects of the disclosure improve the throughput of wireless communications by enabling the use of FDD frequency bands in scenarios in which self-interference would otherwise render the frequency band unusable. Although examples are described primarily for cellular networks, the inventive concepts described herein extend to wireless communications in general. The advantageous operations are accomplished, at least in part, by assigning a second UE-specific CHBW of a UL channel to a UE for transmission, wherein transmitting using the second UE-specific CHBW generates a second relative level of interference in a DL channel, wherein the second UE-specific CHBW has less bandwidth than a first UE-specific CHBW, and wherein the second relative level of interference is lower than a first relative level of interference (of the first UE-specific CHBW).

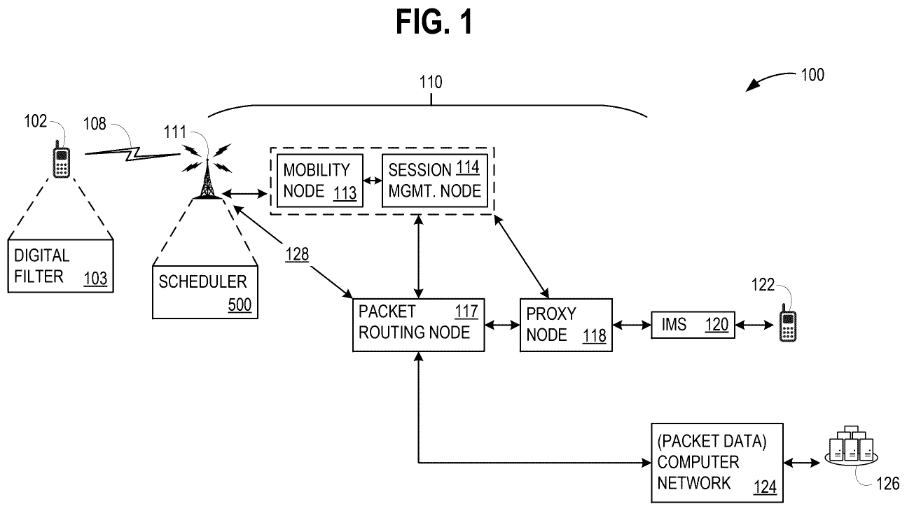

With reference now to the figures, FIG. 1 illustrates an exemplary architecture 100 that advantageously employs UE-specific channel bandwidth for self-interference mitigation. A wireless network 110 is illustrated that is serving a UE 102. UE 102 may be an enhanced mobile broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network.

In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, and other components (not shown). Wireless network 110 also has a packet routing node 117 and a proxy node 118. Mobility node 113 and session management node 114 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and proxy node 118. Packet routing node 117 is in communication with proxy node 118 and computer network 124. In some 5G examples, base station 111 comprises a gNodeB (gNB), mobility node 113 comprises an access mobility function (AMF), session management node 114 comprises a session management function (SMF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using computer network 124 (or IMS 120, in some examples). Data packets of data traffic 128 to/from UE 102 pass through at least base station 111 and packet routing node 117 on their way from/to computer network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, a scheduler 500 assigns UE-specific CHBWs to reduce self-interference for UEs that are using wireless network 110. A digital filter 103, within UE 102 adjusts to the assigned UE-specific CHBW to further limit self-interference, as described below. Although FIG. 1 and some of the following figures are described using an example of a cellular network, it should be understood that the teachings herein are applicable to other types of wireless networks. To benefit from the teachings herein, another wireless network, other than a cellular network, should employ FDD communication, with the ability to control a UE to use asymmetric DL and UL bandwidths. With such features, another type of wireless network, other than a cellular network, may also benefit from the disclosure herein.

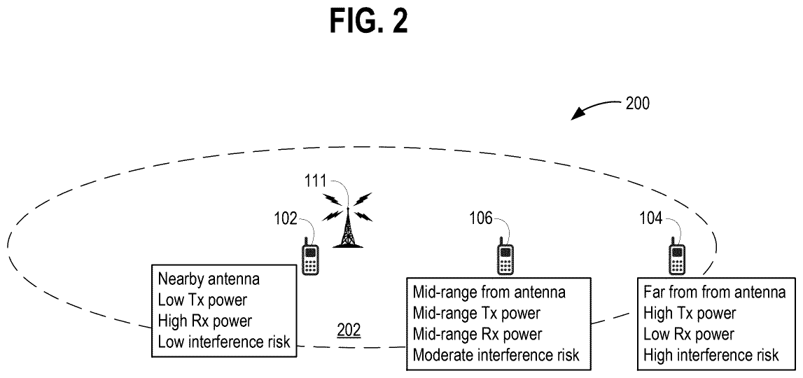

FIG. 2 illustrates a scenario 200 in which base station 111 provides a cell 202 that serves UE 102, a second UE 104, and a third UE 106. UE 102 is nearby base station 111, and so needs only low transmit power, while enjoying relatively high receive power. This creates a low risk of self-interference. UE 104, however is far from base station 111, near the outer edge of cell 202. UE 104 thus requires high transmit power to reach base station 111, and the received signals from base station 111 have relatively low power. This creates a high risk of interference. UE 106 is in the middle, between UE 102 and UE 104, for distance from base station 111, transmit power, receive power, and risk of interference.

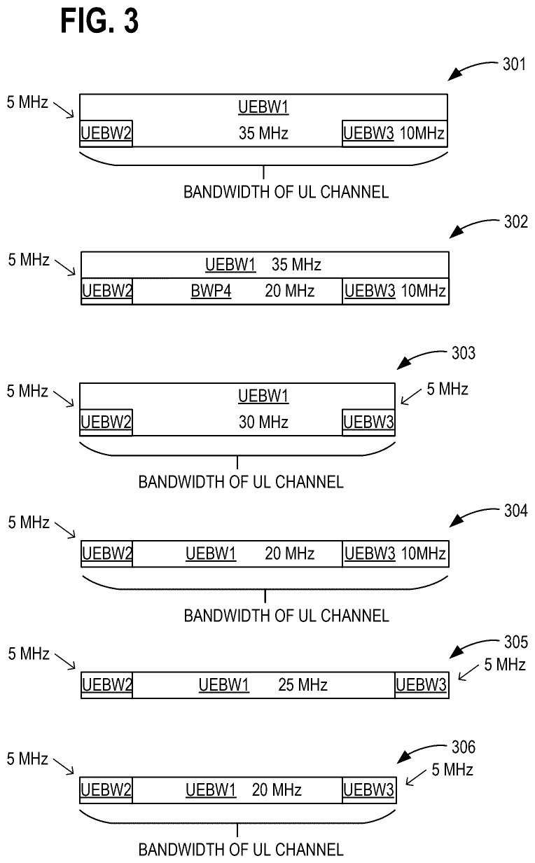

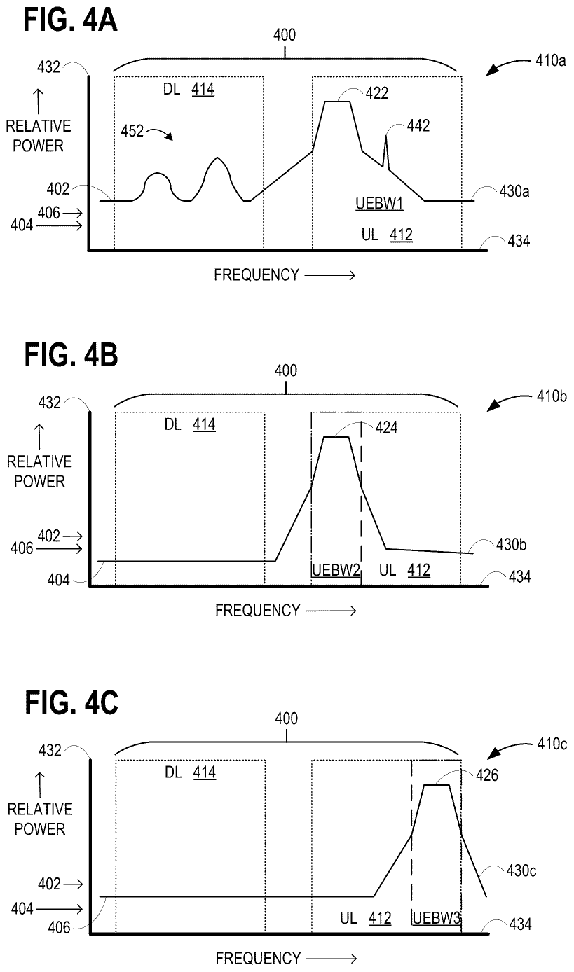

FIG. 3 illustrates exemplary UE-specific CHBWs that may be used in examples of architecture 100. Six examples are illustrated, showing various bandwidths for different UE-specific CHBWs, for a UL channel 412 (see FIGS. 4A and 4B), and whether UE-specific CHBWs overlap in frequency, or are adjacent but not overlapping. The six examples shown are not intended to reflect all possible combinations, but instead indicate the flexibility and wide range of the possible arrangements.

Example 301 shows a first UE-specific CHBW, labeled UEBW1, that takes up the entire bandwidth of UL channel 412, and is 35 megahertz (MHz). A second UE-specific CHBW, labeled UEBW2, overlaps with UEBW1, but is only 5 MHz. UEBW2 has less potential throughput than UEBW1, because UEBW2 has less bandwidth than UEBW1. UEBW2 also has less flexibility for scheduling resource blocks (RBs) for transmission. Therefore, UEBW2 is generally less preferable to use than UEBW1. However, as explained relative to FIGS. 4A and 4B, a UE generates less self-interference by using UEBW2 than by using UEBW1. A third UE-specific CHBW, labeled UEBW3, is also shown that is 10 MHz. UEBW3 also generates less self-interference than UEBW1, but more than UEBW2.

However, since UEBW3 has more bandwidth that UEBW2, it may offer more throughput or more flexibility in scheduling RBs than UEBW2. Thus, UEBW3 is an intermediate solution-more preferable than UEBW2, but less interference than UEBW1. Examples of architecture 100 may use two UE-specific CHBWs, three UE-specific CHBWs, or even more UE-specific CHBWs.

Example 302 has four UE-specific CHBWs. A fourth UE-specific CHBW, labeled UEBW4, is added to example 301, spanning the 20 MHz between UEBW2 and UEBW3. In some examples, UEBW4 may be an initial default for a UE newly registered to base station 111, until it can be decided whether the received signal quality can tolerate a higher level of interference, and the UE is moved up to the 35 MHz of UEBW1, or drops down to the more restrictive (but lower interference) UEBW2 or UEBW3.

Example 303 is similar to example 301 in that there are three UE-specific CHBWs and both UEBW2 and UEBW3 overlap with UEBW1. However, in example 303, UEBW1 is 30 MHz and UEBW3 is 5 MHz. UEBW1, for example, may be 20 MHz, 25 MHz, 30 MHz, 35 MHz, or another bandwidth. Similarly, UEBW3 may have a bandwidth of 5 MHz, 10 MHz, 20 MHz, or another value. It should also be understood that UEBW2 may have a different bandwidth than 5 MHz, and may also be moved to the upper end of UEBW1, or be another place within the frequencies of UL channel 412.

Example 304 illustrates an alternative, in which the UE-specific CHBWs do not overlap, but instead are adjacent in frequency. For example, UEBW2 is adjacent to the low end of UEBW1, and UEBW3 is adjacent to the high end of UEBW1. Thus, UL channel 412 is divided into UEBW2, UEBW1, and UEBW3, in ascending order of frequency (as shown), but may instead be in descending order of frequency.

In example 304, UEBW1 is 20 MHz, and UEBW3 is 10 MHz. Example 305 is similar to example 304, although UEBW1 is 25 MHz, and UEBW3 is 5 MHz. Example 306 is also similar to example 304, although UEBW3 is 5 MHz. Thus, it should be understood that various bandwidths may be used for the different UE-specific CHBWs, along with different positions in frequency, and different arrangements of whether any UE-specific CHBWs overlap in frequency.

FIGS. 4A, 4B, and 4C illustrate exemplary power spectral density plots for UEBW1 (FIG. 4A), UEBW2 (FIG. 4B), and UEBW3 (FIG. 4C). FIGS. 4A, 4B, and 4C each show wireless frequency band 400 as FDD, with both UL channel 412 and a DL channel 414, against a relative power axis 432 and a frequency axis 434. In some examples, wireless frequency band 400 may be in the 600 MHz range, with UL channel 412 ranging from 663 MHz to 698 MHz and DL channel 414 ranging from 617 MHz to 652 MHz. In such an example, UL channel 412 is at a higher frequency than DL channel 414. In some examples, UL channel 412 may be at the lower frequency. In some examples, UL channel 412 and DL channel 414 have symmetric bandwidths for a given UE.

In some examples, UL channel 412 and DL channel 414 have asymmetric bandwidths for a given UE. In such examples, the UE uses all of the bandwidth for DL channel 414, but only a narrower UE-specific CHBW for the UL. However, some UEs may not support asymmetric UL/DL bandwidths. In those examples, symmetric BWPs may be used for UL and DL, such that the UE uses only a BWP of DL channel 414 (less than the entirety of DL channel 414) that is as wide as the assigned UE-specific CHBW for that UE (and corresponds to a BWP). Limiting the bandwidth of the DL for a UE may further limit self-interference in some scenarios.

FIG. 4A shows a power spectral density plot 410a for a power spectrum curve 430a, plotted as relative (normalized) power as a function of frequency, for transmitting a set of RBs using frequencies near the lower end of UEBW1. This is indicated by a peak 422 in power spectrum curve 430a near the lower end of UL channel 412, closer to DL channel 414. Unfortunately, power spectrum curve 430a shows that transmission of UEBW1 is not entirely clean in the frequency spectrum, but instead spills interference into DL channel 414 at a relative level of interference 402.

A spectral spike 442 is at the center of UEBW1, which is also at the center of UL channel 412, because in this scenario UEBW1 spans the frequency range of UL channel 412. Spectral spike 442 is an artifact of the radio frequency (RF) generation and modulation arrangement in a UE. The offset of peak 422 (due to the frequencies of the RBs used) from spectral spike 442 results in a lobing structure 452 in power spectrum curve 430a within the frequencies of DL channel 414. This lobing structure 452 serves to increase the amount of interference power spilled from UL channel 412 into DL channel 414 (i.e., increases relative level of interference 402).

In addition to the fixed analog duplex filter, there is a digital filter 103 in the UE (e.g., UE 102, UE 104, or UE 106) which adjusts to allow all of UEBW1 to pass, when the UE is using UEBW1. Unfortunately, no filtering is perfect, and spectral emissions to bleed through (although attenuated), outside the passband of digital filter 103. Thus, transmitting using UEBW1 generates relative level of interference 402 in DL channel 414.

Although relative level of interference 402 is indicated as a certain value, relative to relative power axis 432, is should be understood that relative level of interference 402 is actually the (normalized) cumulative power of the interference received by a UE that is demodulating RBs within DL channel 414, and so more closely resembles an integration of the area under power spectrum curve 430a within DL channel 414—which includes lobing structure 452. It is important to note that some DL RBs may be more impacted by interference than others, and hence scheduling particular DL RBs for affected UE may also help to minimize self-interference.

FIG. 4B shows a power spectral density plot 410b for a power spectrum curve 430b, plotted as relative power as a function of frequency, for transmitting a set of RBs using UEBW2, that match the same set of frequencies indicated for RBs in FIG. 4A. Power spectrum curve 430b has a peak 424 that is at the same location as peak 422. However, because UEBW2 is narrower than UEBW1, the position of peak 424 is in the middle of UEBW2, whereas when UEBW1 was used (in FIG. 4A) peak 422 was at the edge of UEBW1. Because peak 424 is at the center of center of UEBW2, any spectral spike that would otherwise occur at the center of UEBW2 is obscured.

Since there is no offset of peak 424 from a spectral spike, power spectrum curve 430b has a relatively clean roll-off as it passes outside UL channel 412, and there is no lobing structure within the frequencies of DL channel 414 that is equivalent to lobing structure 452 of power spectrum curve 430a. The intermodulation effect is reduced, or absent, when using UEBW2. This serves to decrease the amount of interference power spilled from UL channel 412 into DL channel 414.

In addition to the fixed analog duplex filter, the digital filter 103 in the UE adjusts to allow all of UEBW2 to pass, when the UE is using UEBW2. Unfortunately, no filtering is perfect, and spectral emissions to bleed through (although attenuated), outside the passband of digital filter 103. Thus, transmitting using UEBW2 generates relative level of interference 404 in DL channel 414. A spectrum emission mask (SEM) is a function of the configured RF bandwidth, which limits transmitted emissions, thereby impacting self-interference by limiting the strength of transmitted signal into the received DL signal.

Although the reduction in self-interference may be primarily due to less intermodulation, the narrower passband of digital filter 103 may also further reduce self-interference. The effect of digital filter 103 may be less noticeable when the edges of UEBW2 and UEBW1 are both the same distance (measured in frequency) from DL channel 414, however, when UEBW2 is further from DL channel 414 than is UEBW1, digital filter 103 can further reduce self-interference.

Thus, relative level of interference 404 (for UEBW2) is lower than relative level of interference 402 (for UEBW1). Ideally, relative level of interference 404 would be zero, but imperfections in RF generation and filtering generally prevent this from being the case.

Although relative level of interference 404 is indicated as a certain value, relative to relative power axis 432, is should be understood that relative level of interference 404 is actually the (normalized) cumulative power of the interference received by a UE that is demodulating RBs within DL channel 414, and so more closely resembles an integration of the area under power spectrum curve 430b within DL channel 414.

As shown in FIG. 4C, transmitting using UEBW3 generates a relative level of interference 406 in DL channel 414. A power spectrum curve 430c, for UEBW3, has a peak 426 that obscures any spectral spike that would otherwise occur at the center of UEBW2. However, because RF power spectral behavior is complex, it is possible for UEBW3 to produce more interference in DL channel 414 than does UEBW2. This is a possibility in some examples. However, in other examples, the UE-specific CHBW that is farthest from DL channel 414 produces the lowest interference.

Although relative level of interference 406, for UEBW3, is indicated as a certain value, relative to relative power axis 432, it should be understood that relative level of interference 406 is actually the (normalized) cumulative power of the interference received by a UE that is demodulating RBs within DL channel 414, and so more closely resembles an integration of the area under power spectrum curve 430c within DL channel 414.

While the overall relative level of self-interference is a function of the power integrated over the receive band, in an orthogonal frequency division multiplexing (OFDM) arrangement, symbols in different sub-carries may produce differing levels of interference-some more than others. Generally, the symbols producing less interference will result in a lower error rate. Therefore, scheduling particular DL RBs or limiting the DL to particular UE specific CHBWs may also be useful to reduce interference.

In the examples described herein, relative level of interference 404 is lower than relative level of interference 402, and relative level of interference 406 is lower than relative level of interference 402 but higher than relative level of interference 404. The effects which render relative level of interference 404 for UEBW2 lower than relative level of interference 402 for UEBW1 are leveraged for UEBW3, although to a lesser extent, in order to permit UEBW3 to have higher throughput, in some examples. This enables UEBW3 to be an intermediate between UEBW1 and UEBW2 in examples that use at least three UE-specific CHBWs. Use of the concepts disclosed herein require merely identifying the relative levels of interference caused by different UE-specific CHBWs, rather than resolution of complex RF generation issues that cause such interference.

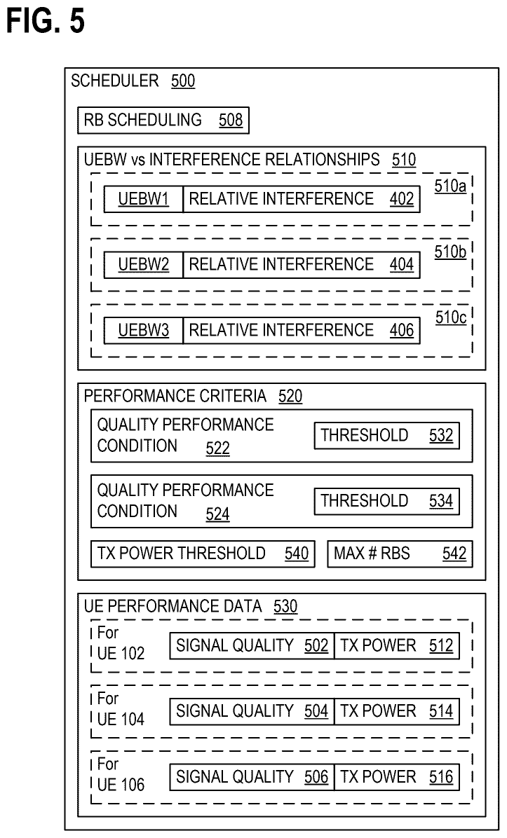

FIG. 5 illustrates further detail for scheduler 500. Scheduler 500 has RB scheduling logic 508 that schedules RBs for UEs being served by base station 111, such as based on the amount of data each UE indicates it has in its transmit buffer. However, RB scheduling logic 508 uses only RBs, for each UE, based on the UE-specific CHBW assigned to that UE. That is, different RBs use different frequencies, so only RBs within the frequencies of a UE-specific CHBW assigned to a UE are available to schedule for that UE.

Scheduler 500 has a data set showing relationships 510 between UE-specific CHBWs (e.g., UEBW1, UEBW2, and UEBW3) and relative levels of interference, which may have been determined using simulation and/or measurement of various UE RF performance. As shown UEBW1 is associated with relative level of interference 402 in a relationship 510a; UEBW2 is associated with relative level of interference 404 in a relationship 510b; and UEBW3 is associated with relative level of interference 406 in a relationship 510c. Although three relationships between UE-specific CHBWs and relative levels of interference are shown, some examples may use a different number.

Scheduler 500 also has performance criteria 520, which includes a first radio signal quality performance condition 522, which may be a radio signal quality threshold 532, and a second radio signal quality performance condition 524, which may be a radio signal quality threshold 534. Radio signal quality performance condition 522 and radio signal quality performance condition 524 are used to determine when a UE has a sufficiently clean signal quality (such as UE 102) that interference mitigation is a low priority, or whether the UE is in need of interference mitigation (such as UE 104).

Some examples only use a single performance threshold for determining whether interference mitigation is needed, and use two UE-specific CHBWs (UEBW1 and UEBW2). Some examples use two performance thresholds for determining whether (and how much) interference mitigation is needed, and use three UE-specific CHBWs (UEBW1, UEBW2, and UEBW3). In examples that use two performance thresholds, radio signal quality performance condition 524 is higher than radio signal quality performance condition 522. In this situation, when a UE fails to meet the lower threshold, radio signal quality performance condition 522, the UE-specific CHBW available for that UE to use is restricted to the UE-specific CHBW having the lowest level of interference (UEBW2).

When a UE meets the lowest threshold, but fails to meet the highest threshold, radio signal quality performance condition 524, the UE-specific CHBWs available for that UE to use is restricted to the UE-specific CHBWs having the lowest and the second lowest levels of interference (UEBW2 and UEBW3). When a UE meets the highest threshold, the UE-specific CHBWs available for that UE to use are not restricted (i.e., any of UEBW1, UEBW2, and UEBW3 may be used).

Some examples also limit UEs to a maximum number of RBs 542, which may be 20 (or another number), when interference mitigation is needed. In some examples, when a UE's transmit power exceeds a transmit power threshold 540, the UE-specific CHBW is limited to a UE-specific CHBW having lower interference, such as reducing the UE from UEBW1 to UEBW3 or from UEBW3 to UEBW2. Some examples only apply maximum number of RBs 542 to UEs using UEBW2 or UEBW3, because the first tier of interference reduction is moving off of UEBW1.

Scheduler 500 also has UE performance data 530, which includes a radio signal quality parameter 502 and a transmit power 512 for UE 102, a radio signal quality parameter 504 and a transmit power 514 for UE 104, and a radio signal quality parameter 506 and a transmit power 516 for UE 106. Transmit power 512, transmit power 514, and transmit power 516 may be determined using UL power headroom values, which is reported in a power headroom report (PHR) by each of UEs 102-106. Radio signal quality parameters 502, 504, and 506 are for DL channel 414, as received by each of UEs 102-106, and may be any of (or a combination of any of): block error rate (BLER), channel state information (CSI), received signal strength indicator (RSSI), reference signal receive power (RSRP), reference signal received quality (RSRQ), and signal to interference plus noise ratio (SINR).

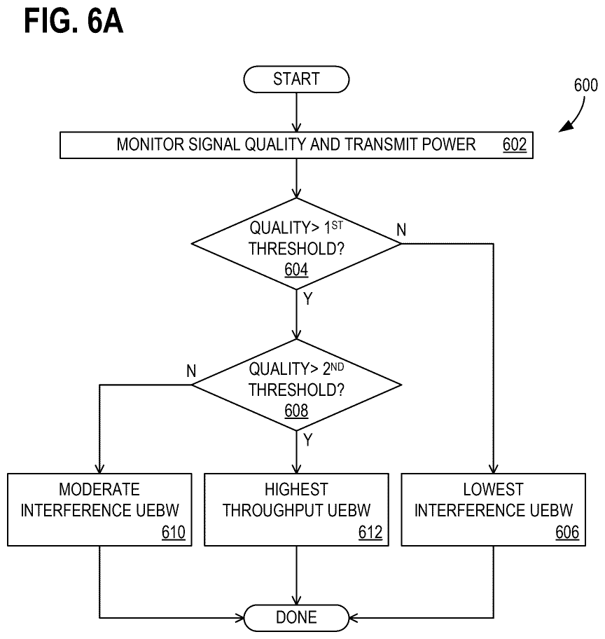

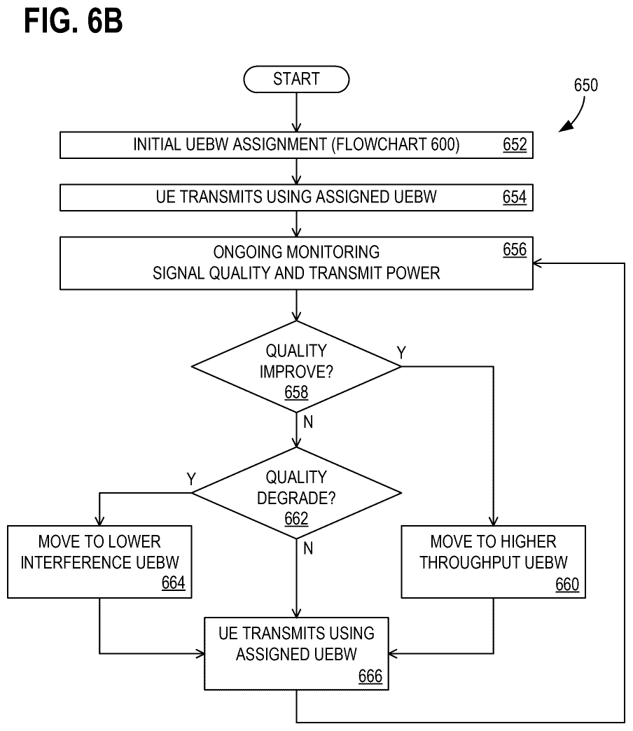

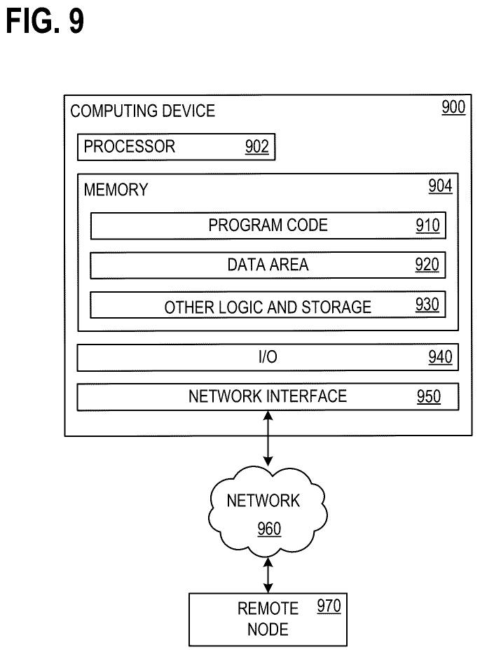

FIG. 6A illustrates a flowchart 600 of exemplary operations associated with examples of architecture 100. In some examples, at least a portion of flowchart 600 may be performed using one or more computing devices 900 of FIG. 9. Flowchart 600 shows the logic for selecting a UE-specific CHBW for a UE. Flowchart 600 commences with monitoring signal quality and transmit power for a UE, in operation 602. For example, scheduler 500 monitors radio signal quality parameter 502 and transmit power 512 for UE 102, radio signal quality parameter 504 and transmit power 514 for UE 104, and radio signal quality parameter 506 and transmit power 516 for UE 106.

Decision operation 604 determines whether the radio signal quality parameter for a UE meets radio signal quality performance condition 522 (e.g., meets radio signal quality threshold 532). If not, operation 606 limits that UE to using only UEBW2. This is the situation for UE 104.

Otherwise, if the radio signal quality parameter for a UE meets radio signal quality performance condition 522, decision operation 608 determines whether the radio signal quality parameter for the UE meets radio signal quality performance condition 524 (e.g., meets radio signal quality threshold 534). If not, operation 610 limits that UE to using either UEBW2 or UEBW3. This is the situation for UE 106. That is, UE 106 is permitted to use UEBW3. In some situations, UE 106 may be assigned UEBW2. This may occur based on network traffic conditions and whether UEBW3 is already fully occupied by other UEs, and so is just not available for UE 106. However, if the radio signal quality parameter for a UE meets radio signal quality performance condition 524, operation 612 permits that UE to use any of UE-specific CHBW. This is the situation for UE 102. That is, UE 102 is permitted to use UEBW1.

FIG. 6B illustrates a flowchart 650 of exemplary operations associated with examples of architecture 100. In some examples, at least a portion of flowchart 650 may be performed using one or more computing devices 900 of FIG. 9. Flowchart 650 shows the logic for ongoing monitoring of a UE and changing the UE-specific CHBW, if necessary. Operation 652 is the initial UE-specific CHBW assignment, such as by using flowchart 600 of FIG. 6A. The UE transmits data using its assigned UE-specific CHBW in operation 654. Operation 656 is the ongoing monitoring of the UE, both its radio signal quality parameter and its transmit power.

Decision operation 658 determines whether the radio signal quality parameter has improved sufficiently for that UE to use a UE-specific CHBW with higher throughput. If so, the UE is moved to the new UE-specific CHBW in operation 660. Otherwise, decision operation 662 determines whether the radio signal quality parameter has degraded sufficiently that the UE needs to use a UE-specific CHBW with less interference. If so, the UE is moved to the new UE-specific CHBW in operation 664. The UE transmits data using its assigned UE-specific CHBW in operation 666.

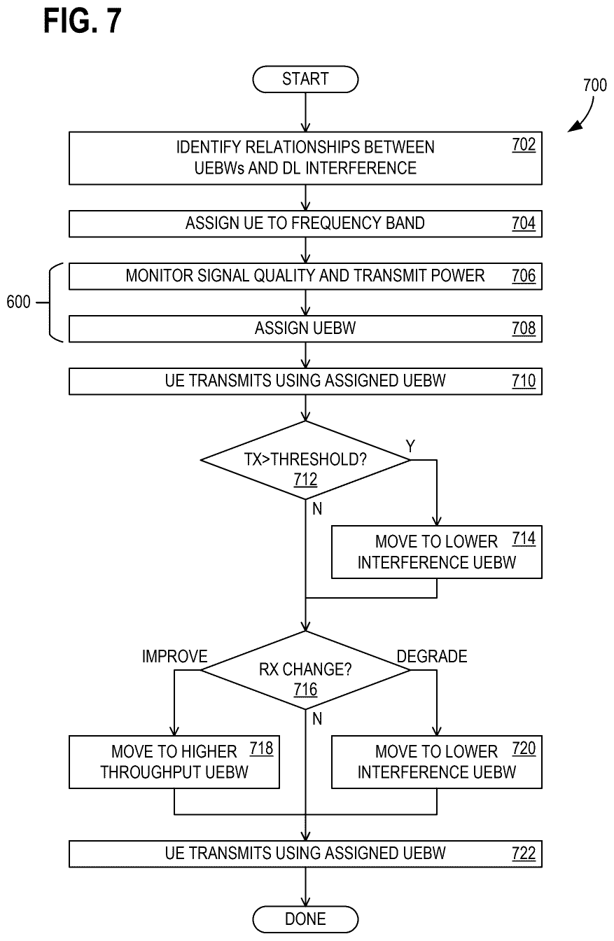

FIG. 7 illustrates a flowchart 700 of exemplary operations associated with examples of architecture 100, specifically, the application of flowchart 650 (of FIG. 6B) to scenario 200 (of FIG. 2). In some examples, at least a portion of flowchart 700 may be performed using one or more computing devices 900 of FIG. 9. Flowchart 700 commences with identifying relationships 510 between UE-specific CHBWs and relative levels of interference 402-406 in DL channel 414 of wireless frequency band 400, in operation 702.

In operation 704, base station 111 assigns UE 102, UE 104, and UE 106 to wireless frequency band 400, creating scenario 200. Flowchart 700 is further described using three passes that take different branches of the decision operations, one pass for UE 102, another for UE 106, and the third for UE 104.

Base station 111 monitors radio signal quality parameter 502 (for DL channel 414) and transmit power 512 for UE 102 in operation 706. In examples that use two UE-specific CHBWs (i.e., only UEBW1 and UEBW2), in operation 708, scheduler 500 assigns UEBW1 to UE 102 for transmission, based on at least radio signal quality parameter 502 meeting radio signal quality performance condition 522 (e.g., meeting radio signal quality threshold 532). In examples that use three UE-specific CHBWs (UEBW1, UEBW2, and UEBW3), in operation 708, scheduler 500 assigns UEBW1 to UE 102 for transmission, based on at least radio signal quality parameter 502 meeting radio signal quality performance condition 522 and further meeting radio signal quality performance condition 524 (e.g., meeting radio signal quality threshold 534). UE 102 transmits data using its assigned UEBW1, in operation 710.

In some examples, decision operation 712 is performed for UEs assigned to UEBW1 and/or UEBW3. Decision operation 712 determines whether the transmit power of the UE (in this first pass, transmit power 512 of UE 102) meets transmit power threshold 540. If so, flowchart moves to operation 714. This condition will be described for UE 106 in the third pass through for flowchart 700.

Decision operation 716 determines whether the UE's radio signal quality parameter has changed sufficiently to change the assigned UE-specific CHBW. If the radio signal quality performance condition has improved sufficiently then, in operation 718, the UE may be moved to a UE-specific CHBW with higher throughput, although with a higher relative level of interference-if it isn't already at the UE-specific CHBW with the highest throughput. If the radio signal quality performance condition has degraded sufficiently then, in operation 720, the UE may be moved to a UE-specific CHBW with a lower relative level of interference, although with a lower throughput-if it isn't already at the UE-specific CHBW with the lowest relative level of interference.

For this first pass, the scenario of UE 102 having a degradation in its radio signal quality parameter is described. For examples with two UE-specific CHBWs, based on at least determining that radio signal quality parameter 502 has degraded such that it no longer meets radio signal quality performance condition 522, scheduler 500 assigns UEBW2 to UE 102 in operation 718. For examples with three UE-specific CHBWs, based on at least determining that radio signal quality parameter 502 has degraded such that it no longer meets radio signal quality performance condition 524, but does still meet radio signal quality performance condition 522, scheduler 500 assigns UEBW3 to UE 102 in operation 718. UE 102 transmits data using its newly-assigned UEBW2 or UEBW3, in operation 722.

The scenario of the radio signal quality performance condition improving is described for UE 102, in the second pass through flowchart 700. In operation 706 (for the second pass through flowchart 700), base station 111 monitors radio signal quality parameter 504 (for DL channel 414) and transmit power 514 for UE 104. In operation 708, scheduler 500 assigns UEBW2 to UE 104 for transmission, based on at least radio signal quality parameter 504 not meeting radio signal quality performance condition 524. In some examples, UEs that are assigned to a UE-specific CHBW in an effort to mitigate self-interference, such as UEBW2 or UEBW3, that UE is also limited to using maximum number of RBs 542, such as 20. UE 102 transmits data using its assigned UEBW2, in operation 710.

Decision operation 714 determines that radio signal quality parameter 504 has improved sufficiently to meet radio signal quality performance condition 522. So, for examples that use two UE-specific CHBWs, in operation 718, scheduler 500, assigns UEBW1 of UL channel 412 to UE 104, based on at least determining that radio signal quality parameter 504 has improved sufficiently to meet radio signal quality performance condition 522. For examples that use three UE-specific CHBWs, UEBW1 is only assigned if radio signal quality parameter 504 has improved sufficiently to meet radio signal quality performance condition 524. Otherwise if radio signal quality parameter 504 has improved sufficiently to meet radio signal quality performance condition 522, but does not meet radio signal quality performance condition 524, UE 104 is assigned UEBW3. UE 104 transmits data using its newly-assigned UEBW1 or UEBW3, in operation 722.

For the third pass through flowchart 700, described for UE 106, the example of three UE-specific CHBWs is used. Base station 111 monitors radio signal quality parameter 506 (for DL channel 414) and transmit power 516 (for UL channel 412) for UE 106 in operation 706. In operation 708, scheduler 500 assigns UEBW3 to UE 106 for transmission, based on at least radio signal quality parameter 506 meeting radio signal quality performance condition 522 but not meeting radio signal quality performance condition 524. In some examples, UE 106 may also be subjected to limiting RBs to maximum number of RBs 542. UE 106 transmits data using its assigned UEBW3, in operation 710.

Decision operation 712 determines that transmit power 516 of UE 106 meets transmit power threshold 540. Based on at least determining that transmit power 516 of UE 106 meets transmit power threshold 540, scheduler 500 assigs UEBW2 to UE 106 for transmission, in operation 714. This is because UEBW2 has a lower relative level of interference than does UEBW3. Decision operation 716 determines that radio signal quality performance condition 524 has not changed sufficiently to reconsider the UE-specific CHBW assignment. UE 106 transmits data using its assigned UEBW2, in operation 722.

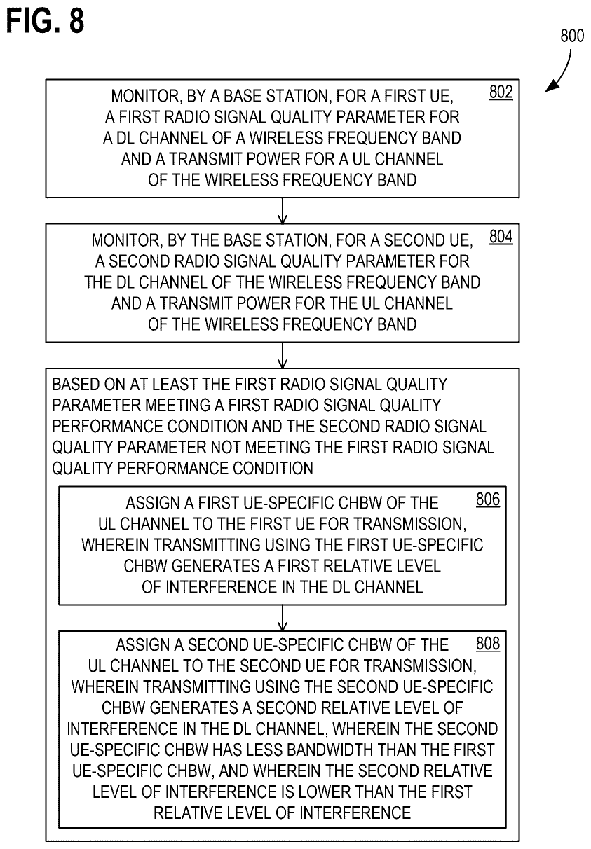

FIG. 8 illustrates a flowchart 800 of exemplary operations associated with architecture 100. In some examples, at least a portion of flowchart 800 may be performed using one or more computing devices 900 of FIG. 9. Flowchart 800 commences with operation 802, which includes monitoring, by a base station, for a first UE, a first radio signal quality parameter for a DL channel of a wireless frequency band and a transmit power for a UL channel of the wireless frequency band. Operation 804 includes monitoring, by the base station, for a second UE, a second radio signal quality parameter for the DL channel of the wireless frequency band and a transmit power for the UL channel of the wireless frequency band.

Operations 806 and 808 are based on at least the first radio signal quality parameter meeting a first radio signal quality performance condition and the second radio signal quality parameter not meeting the first radio signal quality performance condition, respectively. Operation 806 includes assigning a first UE-specific CHBW of the UL channel to the first UE for transmission, wherein transmitting using the first UE-specific CHBW generates a first relative level of interference in the DL channel. Operation 808 includes assigning a second UE-specific CHBW of the UL channel to the second UE for transmission, wherein transmitting using the second UE-specific CHBW generates a second relative level of interference in the DL channel, wherein the second UE-specific CHBW has less bandwidth than the first UE-specific CHBW, and wherein the second relative level of interference is lower than the first relative level of interference.

FIG. 9 illustrates a block diagram of computing device 900 that may be used as any component described herein that may require computational or storage capacity. Computing device 900 has at least a processor 902 and a memory 904 that holds program code 910, data area 920, and other logic and storage 930. Memory 904 is any device allowing information, such as computer executable instructions and/or other data, to be stored and retrieved. For example, memory 904 may include one or more random access memory (RAM) modules, flash memory modules, hard disks, solid-state disks, persistent memory devices, and/or optical disks. Program code 910 comprises computer executable instructions and computer executable components including instructions used to perform operations described herein. Data area 920 holds data used to perform operations described herein. Memory 904 also includes other logic and storage 930 that performs or facilitates other functions disclosed herein or otherwise required of computing device 900. An input/output (I/O) component 940 facilitates receiving input from users and other devices and generating displays for users and outputs for other devices. A network interface 950 permits communication over external computer network 960 (e.g., computer network 124) with a remote node 970, which may represent another implementation of computing device 900. For example, a remote node 970 may represent another of the above-noted nodes within architecture 100.

### Additional Examples

An example system comprises: a processor; and a computer-readable medium storing instructions that are operative upon execution by the processor to: monitor, by a base station, for a first UE, a first radio signal quality parameter for a DL channel of a wireless frequency band and a transmit power for a UL channel of the wireless frequency band; monitor, by the base station, for a second UE, a second radio signal quality parameter for the DL channel of the wireless frequency band and a transmit power for the UL channel of the wireless frequency band; and based on at least the first radio signal quality parameter meeting a first radio signal quality performance condition and the second radio signal quality parameter not meeting the first radio signal quality performance condition: assign a first UE-specific CHBW of the UL channel to the first UE for transmission, wherein transmitting using the first UE-specific CHBW generates a first relative level of interference in the DL channel; and assign a second UE-specific CHBW of the UL channel to the second UE for transmission, wherein transmitting using the second UE-specific CHBW generates a second relative level of interference in the DL channel, wherein the second UE-specific CHBW has less bandwidth than the first UE-specific CHBW, and wherein the second relative level of interference is lower than the first relative level of interference.

An example method of wireless communication comprises: monitoring, by a base station, for a first UE, a first radio signal quality parameter for a DL channel of a wireless frequency band and a transmit power for a UL channel of the wireless frequency band; monitoring, by the base station, for a second UE, a second radio signal quality parameter for the DL channel of the wireless frequency band and a transmit power for the UL channel of the wireless frequency band; and based on at least the first radio signal quality parameter meeting a first radio signal quality performance condition and the second radio signal quality parameter not meeting the first radio signal quality performance condition: assigning a first UE-specific CHBW of the UL channel to the first UE for transmission, wherein transmitting using the first UE-specific CHBW generates a first relative level of interference in the DL channel; and assigning a second UE-specific CHBW of the UL channel to the second UE for transmission, wherein transmitting using the second UE-specific CHBW generates a second relative level of interference in the DL channel, wherein the second UE-specific CHBW has less bandwidth than the first UE-specific CHBW, and wherein the second relative level of interference is lower than the first relative level of interference.

One or more example computer storage devices has computer-executable instructions stored thereon, which, upon execution by a computer, cause the computer to perform operations comprising: monitoring, by a base station, for a first UE, a first radio signal quality parameter for a DL channel of a wireless frequency band and a transmit power for a UL channel of the wireless frequency band; monitoring, by the base station, for a second UE, a second radio signal quality parameter for the DL channel of the wireless frequency band and a transmit power for the UL channel of the wireless frequency band; and based on at least the first radio signal quality parameter meeting a first radio signal quality performance condition and the second radio signal quality parameter not meeting the first radio signal quality performance condition: assigning a first UE-specific CHBW of the UL channel to the first UE for transmission, wherein transmitting using the first UE-specific CHBW generates a first relative level of interference in the DL channel; and assigning a second UE-specific CHBW of the UL channel to the second UE for transmission, wherein transmitting using the second UE-specific CHBW generates a second relative level of interference in the DL channel, wherein the second UE-specific CHBW has less bandwidth than the first UE-specific CHBW, and wherein the second relative level of interference is lower than the first relative level of interference.

Alternatively, or in addition to the other examples described herein, examples include any combination of the following:
the wireless network comprises a cellular network;
the UE comprises a cellular phone, an eMBB, an FWA device, or a computer with a cellular modem;
the base station is a base station of a cellular network;
the base station comprises a gNB or an eNB;
the wireless frequency band is an FDD band of a cellular network;
the first radio signal quality parameter further meets a second radio signal quality performance condition;
monitoring, by the base station, for a third UE, a third radio signal quality parameter for the DL channel of the wireless frequency band and a transmit power for the UL channel of the wireless frequency band;
based on at least the third radio signal quality parameter meeting the first radio signal quality performance condition but not meeting the second radio signal quality performance condition, assigning a third UE-specific CHBW of the UL channel to the third UE for transmission;
transmitting using the third UE-specific CHBW generates a third relative level of interference in the DL channel;
the third UE-specific CHBW differs from both the first UE-specific CHBW and the second UE-specific CHBW;
the third relative level of interference is lower than the first relative level of interference and higher than the second relative level of interference;
the third UE-specific CHBW has less bandwidth than the first UE-specific CHBW;
the first UE-specific CHBW and the second UE-specific CHBW either overlap in frequency or are adjacent in frequency;
the first UE-specific CHBW and the third UE-specific CHBW either overlap in frequency or are adjacent in frequency;
based on at least determining that a transmit power of the third UE meets a transmit power threshold, assigning the second UE-specific CHBW of the UL channel to the third UE for transmission;
the first radio signal quality parameter and the second radio signal quality parameter each comprises at least one parameter selected from the list consisting of: BLER, CSI, RSSI, RSRP, RSRQ, and SINR;
based on at least determining that the first radio signal quality parameter has degraded such that it no longer meets the first radio signal quality performance condition, assigning the second UE-specific CHBW of the UL channel to the first UE for transmission; based on at least determining that the second radio signal quality parameter has improved sufficiently to meet the first radio signal quality performance condition, assigning the first UE-specific CHBW of the UL channel to the second UE for transmission;
the first UE-specific CHBW has a bandwidth of 20 MHz;
the first UE-specific CHBW has a bandwidth of the entire UL channel;
the second UE-specific CHBW has a bandwidth of 5 MHz;
the third UE-specific CHBW has a bandwidth of 5 MHz, 10 MHz, or 20 MHz;
the UL channel and the DL channel have asymmetric bandwidths for the second UE;
the UL channel and the DL channel have symmetric bandwidths for the second UE;
based on at least determining that the first radio signal quality parameter has degraded such that it no longer meets the second radio signal quality performance condition, but does still meet the first radio signal quality performance condition, assigning the third UE-specific CHBW of the UL channel to the first UE for transmission;
based on at least determining that the second radio signal quality parameter has improved sufficiently to meet the second radio signal quality performance condition, assigning the first UE-specific CHBW of the UL channel to the second UE for transmission;
based on at least determining that the second radio signal quality parameter has improved sufficiently to meet the first radio signal quality performance condition, but does not meet the second radio signal quality performance condition, assigning the third UE-specific CHBW of the UL channel to the second UE for transmission;
limiting the second UE to a maximum number of RBs;
limiting the third UE to the maximum number of RBs;
the maximum number of RBs is 20;
the UL channel is divided into the second UE-specific CHBW, the first UE-specific CHBW, and the third UE-specific CHBW, in either ascending order of frequency or descending order of frequency;
the first UE-specific CHBW is adjacent in frequency to both the second UE-specific CHBW and the third UE-specific CHBW;
assigning, by the base station, the first UE, the second UE, and the third UE to the wireless frequency band;
the first radio signal quality performance condition comprises a first radio signal quality threshold; and
the second radio signal quality performance condition comprises a second radio signal quality threshold.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
monitoring, by a base station, for a first user equipment (UE), a first radio signal quality parameter for a downlink (DL) channel of a wireless frequency band and a transmit power for an uplink (UL) channel of the wireless frequency band;
monitoring, by the base station, for a second UE, a second radio signal quality parameter for the DL channel of the wireless frequency band and a transmit power for the UL channel of the wireless frequency band; and
based on at least the first radio signal quality parameter meeting a first radio signal quality performance condition and the second radio signal quality parameter not meeting the first radio signal quality performance condition:
assigning a first UE-specific channel bandwidth (UE-specific CHBW) of the UL channel to the first UE for transmission, wherein transmitting using the first UE-specific CHBW generates a first relative level of interference in the DL channel; and
assigning a second UE-specific CHBW of the UL channel to the second UE for transmission, wherein transmitting using the second UE-specific CHBW generates a second relative level of interference in the DL channel, wherein the second UE-specific CHBW has less bandwidth than the first UE-specific CHBW, and wherein the second relative level of interference is lower than the first relative level of interference.

2. The method of claim 1, wherein the first radio signal quality parameter further meets a second radio signal quality performance condition, and wherein the method further comprises:
monitoring, by the base station, for a third UE, a third radio signal quality parameter for the DL channel of the wireless frequency band and a transmit power for the UL channel of the wireless frequency band; and
based on at least the third radio signal quality parameter meeting the first radio signal quality performance condition but not meeting the second radio signal quality performance condition:
assigning a third UE-specific CHBW of the UL channel to the third UE for transmission, wherein transmitting using the third UE-specific CHBW generates a third relative level of interference in the DL channel, wherein the third UE-specific CHBW from both the first UE-specific CHBW and the second UE-specific CHBW, and wherein the third relative level of interference is lower than the first relative level of interference and higher than the second relative level of interference.

3. The method of claim 2,
wherein the third UE-specific CHBW has less bandwidth than the first UE-specific CHBW;
wherein the first UE-specific CHBW and the second UE-specific CHBW either overlap in frequency or are adjacent in frequency; and
wherein the first UE-specific CHBW and the third UE-specific CHBW either overlap in frequency or are adjacent in frequency.

4. The method of claim 2, further comprising:
based on at least determining that a transmit power of the third UE meets a transmit power threshold, assigning the second UE-specific CHBW of the UL channel to the third UE for transmission.

5. The method of claim 2,
wherein the first UE-specific CHBW has a bandwidth of 20 megahertz (MHz) or a bandwidth of the UL channel;
wherein the second UE-specific CHBW has a bandwidth of 5 MHz; and
wherein the third UE-specific CHBW has a bandwidth of 5 MHz, 10 MHz, or 20 MHz.

6. The method of claim 1, wherein the first radio signal quality parameter and the second radio signal quality parameter each comprises at least one parameter selected from the list consisting of:
block error rate (BLER), channel state information (CSI), received signal strength indicator (RSSI), reference signal receive power (RSRP), reference signal received quality (RSRQ), and signal to interference plus noise ratio (SINR).

7. The method of claim 1, further comprising:
based on at least determining that the first radio signal quality parameter has degraded such that it no longer meets the first radio signal quality performance condition, assigning the second UE-specific CHBW of the UL channel to the first UE for transmission; or
based on at least determining that the second radio signal quality parameter has improved sufficiently to meet the first radio signal quality performance condition, assigning the first UE-specific CHBW of the UL channel to the second UE for transmission.

8. A system comprising:
a processor; and
a computer-readable medium storing instructions that are operative upon execution by the processor to:
monitor, by a base station, for a first user equipment (UE), a first radio signal quality parameter for a downlink (DL) channel of a wireless frequency band and a transmit power for an uplink (UL) channel of the wireless frequency band;
monitor, by the base station, for a second UE, a second radio signal quality parameter for the DL channel of the wireless frequency band and a transmit power for the UL channel of the wireless frequency band; and
based on at least the first radio signal quality parameter meeting a first radio signal quality performance condition and the second radio signal quality parameter not meeting the first radio signal quality performance condition:
assign a first UE-specific channel bandwidth (UE-specific CHBW) of the UL channel to the first UE for transmission, wherein transmitting using the first UE-specific CHBW generates a first relative level of interference in the DL channel; and
assign a second UE-specific CHBW of the UL channel to the second UE for transmission, wherein transmitting using the second UE-specific CHBW generates a second relative level of interference in the DL channel, wherein the second UE-specific CHBW has less bandwidth than the first UE-specific CHBW, and wherein the second relative level of interference is lower than the first relative level of interference.

9. The system of claim 8, wherein the first radio signal quality parameter further meets a second radio signal quality performance condition, and wherein the instructions are further operative to:
monitor, by the base station, for a third UE, a third radio signal quality parameter for the DL channel of the wireless frequency band and a transmit power for the UL channel of the wireless frequency band; and
based on at least the third radio signal quality parameter meeting the first radio signal quality performance condition but not meeting the second radio signal quality performance condition:
assign a third UE-specific CHBW of the UL channel to the third UE for transmission, wherein transmitting using the third UE-specific CHBW generates a third relative level of interference in the DL channel, wherein the third UE-specific CHBW from both the first UE-specific CHBW and the second UE-specific CHBW, and wherein the third relative level of interference is lower than the first relative level of interference and higher than the second relative level of interference.

10. The system of claim 9,
wherein the third UE-specific CHBW has less bandwidth than the first UE-specific CHBW;
wherein the first UE-specific CHBW and the second UE-specific CHBW either overlap in frequency or are adjacent in frequency; and
wherein the first UE-specific CHBW and the third UE-specific CHBW either overlap in frequency or are adjacent in frequency.

11. The system of claim 9, wherein the instructions are further operative to:
based on at least determining that a transmit power of the third UE meets a transmit power threshold, assign the second UE-specific CHBW of the UL channel to the third UE for transmission.

12. The system of claim 9,
wherein the first UE-specific CHBW has a bandwidth of 20 megahertz (MHz) or a bandwidth of the UL channel;
wherein the second UE-specific CHBW has a bandwidth of 5 MHz; and
wherein the third UE-specific CHBW has a bandwidth of 5 MHz, 10 MHz, or 20 MHz.

13. The system of claim 8, wherein the first radio signal quality parameter and the second radio signal quality parameter each comprises at least one parameter selected from the list consisting of:
block error rate (BLER), channel state information (CSI), received signal strength indicator (RSSI), reference signal receive power (RSRP), reference signal received quality (RSRQ), and signal to interference plus noise ratio (SINR).

14. The system of claim 8, wherein the instructions are further operative to:
based on at least determining that the first radio signal quality parameter has degraded such that it no longer meets the first radio signal quality performance condition, assign the second UE-specific CHBW of the UL channel to the first UE for transmission; or
based on at least determining that the second radio signal quality parameter has improved sufficiently to meet the first radio signal quality performance condition, assign the first UE-specific CHBW of the UL channel to the second UE for transmission.

15. One or more computer storage devices having computer-executable instructions stored thereon, which, upon execution by a computer, cause the computer to perform operations comprising:
monitoring, by a base station, for a first user equipment (UE), a first radio signal quality parameter for a downlink (DL) channel of a wireless frequency band and a transmit power for an uplink (UL) channel of the wireless frequency band;
monitoring, by the base station, for a second UE, a second radio signal quality parameter for the DL channel of the wireless frequency band and a transmit power for the UL channel of the wireless frequency band; and
based on at least the first radio signal quality parameter meeting a first radio signal quality performance condition and the second radio signal quality parameter not meeting the first radio signal quality performance condition:
assigning a first UE-specific channel bandwidth (UE-specific CHBW) of the UL channel to the first UE for transmission, wherein transmitting using the first UE-specific CHBW generates a first relative level of interference in the DL channel; and
assigning a second UE-specific CHBW of the UL channel to the second UE for transmission, wherein transmitting using the second UE-specific CHBW generates a second relative level of interference in the DL channel, wherein the second UE-specific CHBW has less bandwidth than the first UE-specific CHBW, and wherein the second relative level of interference is lower than the first relative level of interference.

16. The one or more computer storage devices of claim 15, wherein the first radio signal quality parameter further meets a second radio signal quality performance condition, and wherein the operations further comprise:
monitoring, by the base station, for a third UE, a third radio signal quality parameter for the DL channel of the wireless frequency band and a transmit power for the UL channel of the wireless frequency band; and
based on at least the third radio signal quality parameter meeting the first radio signal quality performance condition but not meeting the second radio signal quality performance condition:
assigning a third UE-specific CHBW of the UL channel to the third UE for transmission, wherein transmitting using the third UE-specific CHBW generates a third relative level of interference in the DL channel, wherein the third UE-specific CHBW from both the first UE-specific CHBW and the second UE-specific CHBW, and wherein the third relative level of interference is lower than the first relative level of interference and higher than the second relative level of interference.

17. The one or more computer storage devices of claim 16,
wherein the third UE-specific CHBW has less bandwidth than the first UE-specific CHBW;
wherein the first UE-specific CHBW and the second UE-specific CHBW either overlap in frequency or are adjacent in frequency; and
wherein the first UE-specific CHBW and the third UE-specific CHBW either overlap in frequency or are adjacent in frequency.

18. The one or more computer storage devices of claim 16, wherein the operations further comprise:
based on at least determining that a transmit power of the third UE meets a transmit power threshold, assigning the second UE-specific CHBW of the UL channel to the third UE for transmission.

19. The one or more computer storage devices of claim 15, wherein the first radio signal quality parameter and the second radio signal quality parameter each comprises at least one parameter selected from the list consisting of:
block error rate (BLER), channel state information (CSI), received signal strength indicator (RSSI), reference signal receive power (RSRP), reference signal received quality (RSRQ), and signal to interference plus noise ratio (SINR).

20. The one or more computer storage devices of claim 15, wherein the operations further comprise:
based on at least determining that the first radio signal quality parameter has degraded such that it no longer meets the first radio signal quality performance condition, assigning the second UE-specific CHBW of the UL channel to the first UE for transmission; or
based on at least determining that the second radio signal quality parameter has improved sufficiently to meet the first radio signal quality performance condition, assigning the first UE-specific CHBW of the UL channel to the second UE for transmission.
